(19) United States
(12) Patent Application Publication
(10) Pub. No.: US 2024/0309173 A1
(43) Pub. Date: Sep. 19, 2024

(54) GRAPHDIYNE DISPERSION LIQUID, BI-COMPONENT POLYURETHANE ADHESIVE AND PREPARATION METHOD THEREFOR

(71) Applicants: GUANGZHOU BAIYUN TECHNOLOGY CO., LTD., Guangdong (CN); GUANGDONG BAIYUN TECHNOLOGY CO., LTD., Guangdong (CN)

(72) Inventors: JUN SONG, Guangdong (CN); YOU RAO, Guangdong (CN); ZHI YU, Guangdong (CN); JIANJUN CHEN, Guangdong (CN); HENGCHAO HUANG, Guangdong (CN); MINGSONG MIAO, Guangdong (CN)

(73) Assignees: GUANGZHOU BAIYUN TECHNOLOGY CO., LTD., Guangdong (CN); GUANGDONG BAIYUN TECHNOLOGY CO., LTD., Guangdong (CN)

(21) Appl. No.: 18/669,478

(22) Filed: May 20, 2024

Related U.S. Application Data
(63) Continuation of application No. PCT/CN2021/132475, filed on Nov. 23, 2021.

(51) Int. Cl. C08K 3/04; C08G 18/10; C08G 18/18; C08G 18/20; C08G 18/24; C08G 18/48; C09J 11/04; C09J 175/04

(52) U.S. Cl. CPC C08K 3/042; C08G 18/10; C08G 18/1825; C08G 18/2027; C08G 18/242; C08G 18/4825; C09J 11/04; C08G 18/244; C09J 175/04

(57) ABSTRACT

A graphdiyne dispersion liquid, a bi-component polyurethane adhesive and a preparation method therefor, wherein the graphdiyne dispersion liquid is prepared from graphdiyne powder and a polyurethane dispersant; component A of the bi-component polyurethane adhesive comprises a polyurethane prepolymer, an additive and a graphdiyne dispersion liquid, and component B of the bi-component polyurethane adhesive comprises polyol, a catalyst, and a graphdiyne dispersion liquid. The bi-component polyurethane adhesive has relatively good anti-ultraviolet weather resistance and bubble suppression performance during a curing process, and has a potential application value in high-end industrial fields.

### CROSS-REFERENCE TO RELATED APPLICATION

This application is a continuation of international application of PCT application serial no. PCT/CN2021/132475 filed on Nov. 23, 2021. The entirety of the above mentioned patent application is hereby incorporated by reference herein and made a part of this specification.

### BACKGROUND

### Technical Field

The present disclosure relates to the field of adhesive technology, in particular to graphdiyne dispersion liquid, bi-component polyurethane adhesive and preparation method therefor.

### Description of Related Art

Polyurethane adhesive is widely used due to its excellent performance, but it also has inherent defects. Polyurethane adhesive has poorer weather resistance compared with silicone, and is prone to aging when exposed to ultraviolet light. At the same time, the isocyanate groups in isocyanate curing agent are highly reactive and easily react with moisture in the air to produce CO₂, resulting in the formation of pores in the colloid and a decrease in the mechanical properties of the colloid. In severe cases, it may even lead to the failure of the colloid's waterproof or adhesive properties.

Different from graphene materials, graphdiyne contains a highly conjugated linear structure formed by sp hybridized carbon with a large number of carbon-carbon triple bonds and rich electronic configuration characteristics. This microstructure results in graphdiyne having the advantages of a large conjugated system, multiple heteroatom doping sites, and excellent chemical stability, giving graphdiyne materials multiple performance advantages. It has been proven that graphyne has outstanding ultraviolet nonlinear properties and can withstand high-intensity ultraviolet light irradiation. At the same time, the acetylene bond position of graphdiyne has high adsorption affinity for CO₂, and three-dimensional porous graphdiyne can be used as a good adsorption material for CO₂. The above two advantages of graphdiyne can compensate for the disadvantages of polyurethane adhesive, but graphdiyne also has the disadvantage that its structure has poor compatibility with the polyurethane system, making it difficult to increase its addition amount.

In summary, developing a polyurethane material system suitable for the addition of graphdiyne is of great significance for improving the application of graphdiyne.

### SUMMARY

Based on this, one of the objectives of the present disclosure is to provide a graphdiyne dispersion liquid suitable for dispersion in polyurethane adhesive systems, which has good compatibility with polyurethane systems.

The technical solutions to achieve the above objectives include the following.

A graphdiyne dispersion liquid is prepared from graphdiyne powder and polyurethane dispersant, wherein, the polyurethane dispersant is an alkyne-end-capped polyurethane dispersant prepared from isocyanate with two to three functionalities, hydroxyl terminated polybutadiene, as well as 4-pentyne-1-ol as an end-capping agent; the mass fraction of graphdiyne in the graphdiyne dispersion liquid is 10% to 60%.

Another objective of the present disclosure is to provide a bi-component polyurethane adhesive.

The technical solutions to achieve the above objective include the following.

A bi-component polyurethane adhesive, including polyurethane adhesive component A and polyurethane adhesive component B;
wherein, polyurethane adhesive component A is prepared from the following raw materials in parts by weight:
polyurethane prepolymer 100 parts
the graphdiyne dispersion liquid 10 parts to 200 parts
additive 1 part to 4 parts;
the polyurethane prepolymer is prepared from isocyanate with two to three functionalities and polyether polyol as reactants, using 2,4-hexanediyne-1,6-diol as a chain extender;
wherein, the polyurethane adhesive component B is prepared from the following raw materials in parts by weight:
polyol 100 parts
catalyst 0.01 part to 0.1 part;
the graphdiyne dispersion liquid 10 parts to 200 parts
additive 0.1 part to 1 part;
wherein, the polyol is selected from at least one of polyether polyol, polyester polyol, plant polyol, and/or polybutadiene polyol with a viscosity ranging from 1000 mPa·s to 20000 mPa·s (23°° C.);
when using, component A of polyurethane adhesive and component B of polyurethane adhesive are mixed at a mass ratio of 1:1 to 4:1.

Another objective of the present disclosure is to provide a preparation method for the above-mentioned bi-component polyurethane adhesive.

The technical solutions include the following.

The preparation method of the bi-component polyurethane adhesive, comprises the following steps:
stirring polyurethane prepolymer, additive, and the graphdiyne dispersion liquid under vacuum at 20°° C. to 40°° C. for 0.5 hour to 4 hours to obtain a polyurethane adhesive component A;
stirring polyol, catalyst, additive, and the graphdiyne dispersion liquid under vacuum at 20°° C. to 120° C. for 1 hour to 5 hours to obtain a polyurethane adhesive component B.

The present disclosure has the following advantages and beneficial effects compared to prior art.

(1) In the graphdiyne dispersion liquid of the present disclosure, the dispersion prepared by synthesizing carbon-carbon triple bonds and carbon-carbon double bonds on polyurethane molecules can improve the compatibility between polyurethane dispersion and graphdiyne, thereby enhancing the dispersion effect. The preparation of the graphdiyne dispersion liquid avoids the phenomenon of large-scale particle aggregation caused by directly adding graphdiyne into polyurethane adhesive, improves the dispersion effect of graphdiyne, and reduces the viscosity of the system.

(2) Compared to traditional polyurethane prepolymers, the polyurethane prepolymer molecular chains prepared by the present disclosure contain carbon-carbon triple bonds, which can act as intermolecular conjugation with a large number of carbon-carbon triple bonds in graphdiyne, improving the compatibility between polyurethane resin and graphdiyne.

(3) The bi-component polyurethane adhesive with the addition of the graphdiyne dispersion liquid according to the present disclosure can effectively suppress the generation of bubbles, while significantly improving its weather resistance (can block high-intensity ultraviolet light irradiation).

### DESCRIPTION OF THE EMBODIMENTS

The following will further illustrate the technical solutions of the present disclosure through specific embodiments. Technicians in this field should understand that the described embodiments are only intended to help understand the present disclosure and should not be considered as specific limitations to the present disclosure.

Unless otherwise defined, all technical and scientific terms used in the present disclosure have the same meaning as those commonly understood by those skilled in the art to which the present disclosure belongs. The terms used in the description of the present disclosure are for the purpose of describing specific embodiments only and are not intended to limit the present disclosure.

The terms “including” and “having” of the present disclosure, as well as any variations thereof, are intended to cover non-exclusive inclusions. For example, a process, method, device, product, or equipment that includes a series of steps is not limited to the listed steps or modules, but optionally includes steps that are not listed, or alternatively includes other steps inherent to these processes, methods, products, or devices.

The term “multiple” mentioned in the present disclosure refers to two or more. “And/or” describes the relationship of the associated objects, indicating that there can be three types of relationships. For example, A and/or B can represent: the existence of A alone, the coexistence of A and B, and the existence of B alone. The character “/” generally indicates that the associated objects are in an “or” relationship.

One aspect of the present disclosure relates to graphdiyne dispersion liquid, which is prepared from graphdiyne powder and a polyurethane dispersant. The polyurethane dispersant is an alkyne-end-capped polyurethane dispersant prepared from isocyanate with two functionalities and hydroxyl terminated polybutadiene, as well as 4-pentyne-1-ol as an end-capping agent; the mass fraction of graphdiyne in the graphdiyne dispersion liquid is 10% to 60%.

In some embodiments, the mass fraction of graphdiyne in the graphdiyne dispersion liquid was 40% to 60%, further preferably 45% to 55%.

In some embodiments, graphdiyne powder was prepared by a mechanochemical method, which is simple and feasible.

In some embodiments, the isocyanate with two to three functionalities was polymerized MDI (4,4′-diphenylmethane diisocyanate), pure MDI (Diphenylmethane diisocyanate), or liquefied MDI, with a molecular weight of 245 to 255.

In some embodiments, the mass ratio of liquefied MDI to hydroxyl terminated polybutadiene was 100:10 to 110:10 parts.

In some embodiments, the viscosity of the polyurethane dispersant was 100 mPa·s to 10000 mPa·s, preferably 1000 mPa·s to 2000 mPa·s.

In some embodiments, the molecular weight of the hydroxyl terminated polybutadiene was 1000 to 5000, preferably 1500 to 2500.

In some embodiments, the viscosity of the graphdiyne dispersion was 5000 mPa·s to 15000 m Pa·s, more preferably 8000 mPa·s to 10000 mPa·s.

Some embodiments of the present disclosure related to a bi-component polyurethane adhesive, including polyurethane adhesive component A and polyurethane adhesive component B; when using, component A of polyurethane adhesive and component B of polyurethane adhesive are mixed at a mass ratio of 1:1 to 4:1.
wherein, polyurethane adhesive component A was prepared from the following raw materials in parts by weight:
polyurethane prepolymer 100 parts
graphdiyne dispersion liquid 10 parts to 200 parts
additive 1 part to 4 parts;
wherein, the polyurethane prepolymer was prepared from isocyanate with two to three functionalities and polyether polyol as reactants, using 2,4-hexanediyne-1,6-diol as a chain extender.

In some embodiments, polyurethane adhesive component A and polyurethane adhesive component B were mixed in a mass ratio of 1:1 to 2:1, more preferably 1:1.

The isocyanate with two to three functionalities was polymerized MDI (4,4′-diphenylmethane diisocyanate), pure MDI (Diphenylmethane diisocyanate), or liquefied MDI, with a molecular weight of 245 to 255.

The polyurethane prepolymer had good compatibility with graphdiyne in graphdiyne dispersion. The viscosity of polyurethane adhesive component A and/or polyurethane adhesive component B was between 20000m Pa·s to 250000 mPa·s (23°° C.), preferably between 50000 mPa·s to 200000 mPa·s.

In some embodiments, the viscosity of bi-component polyurethane adhesive was between 20000 mPa·s to 200000 mPa·s (23° C.). In some preferred embodiments, the viscosity was 50000 mPa·s to 160000 mPa·s.

In some embodiments, the graphdiyne dispersion liquid was preferably 50 parts to 150 parts, more preferably from 95 parts to 105 parts.

In some embodiments, in the polyurethane prepolymer preparation, the isocyanates with two to three functionalities were a mixture of polymerized MDI, pure MDI, and liquefied MDI.

In some embodiments, the dosage ratio of isocyanates with two to three functionalities, polyether polyols, and 2,4-hexane-1,6-diol was 100:30 to 50:3 to 6 parts by weight.

In some embodiments, the viscosity of polyurethane prepolymer was 20000 mPa·s to 30000 mPa·s (23° C.).

The additive in polyurethane adhesive component A was selected from at least one of thixotropic agent, dust-proof agent, antioxidant, or dehydrating agent.

In some preferred embodiments, the thixotropic agent was gas-phase white carbon black; the dust-proof agent was byk-D410 of Bike Chemical; the dehydrating agent was oxazolidine.

The polyurethane adhesive component B was prepared from the following raw materials in parts by weight:
polyol 100 parts
catalyst 0.01 part to 0.1 part;
graphdiyne dispersion liquid 10 parts to 200 parts
additive 0.1 part to 1 part;
wherein, the polyol is selected from at least one of polyether polyol, polyester polyol, plant polyol, and/or polybutadiene polyol, with a viscosity ranging from 1000 mPa·s to 20000 mPa·s (23° C.).

In some embodiments, the catalyst could be an organic tin catalyst such as stannous octanoate, dibutyltin dilaurate, or a tertiary amine catalyst such as triethylenediamine, triethanolamine, etc. The amount of catalyst added was 0.01% to 0.1% of the total mass of polyols, preferably 0.04% to 0.06%.

In some embodiments, the mass fraction of graphdiyne in the graphdiyne dispersion liquid was 5% to 80%, and the viscosity was between 2000 mPa·s to 100000 mPa·s (23° C.). The total addition amount of the graphdiyne dispersion liquid accounted for 100% to 200% of the polyols, preferably 50% to 150%.

In some embodiments, the additive was one of or a mixture of thixotropic agent, dust-proof agent, antioxidant, or dehydrating agent, and total addition amount accounted for 0.1% to 1% of the polyol, preferably 0.4% to 0.6%.

Some embodiments of the present disclosure related to a preparation method of the bi-component polyurethane adhesive, comprising the following steps:
stirring polyurethane prepolymer, additive, and the aforementioned graphdiyne dispersion liquid under vacuum at 20°° C. to 40° C. for 0.5 hour to 4 hours to obtain a polyurethane adhesive component A;
stirring polyol, catalyst, additive, and the aforementioned graphdiyne dispersion liquid under vacuum at 20°° C. to 120° C. for 1 hour to 5 hours to obtain a polyurethane adhesive component B.

When using, just mix component A of polyurethane adhesive and component B of polyurethane adhesive.

The number of parts involved in the following embodiments refers to the number of parts by mass

The reagents used in the following embodiments are all routinely available.

### Embodiment 1: Preparation of Graphdiyne Dispersion Liquid

Step 1: Preparation of polyurethane dispersant: 100 parts by weight of liquefied MDI type 100LL (MDI with a molecular weight of 250) from Wanhua Chemical Group Co., Ltd, 10 parts by weight of hydroxyl terminated polybutadiene polyol (molecular weight of 2000) from HSC company (CRAY VALLEY), and 0.05 part by weight of dibutyltin dilaurate were added to a reaction vessel and stirred under vacuum at 80°° C. for 3 hours. Then 48 parts by weight of 4-pentyne-1-ol was added and the mixture was stirred at 25° C. for 6 hours to obtain a colorless liquid and stored in dark. The obtained liquid (polyurethane dispersant) had a viscosity of 1000 mPa·s to 2000 mPa·s at 23° C.

The characteristic peaks of the infrared spectrum of the product were as follows: at 3300 cm⁻¹, there was an absorption peak for N—H and carbon-hydrogen bonds on the alkyne; at 3020 cm⁻¹, there was an absorption peak for hydrocarbons around the double bond in polybutadiene; at 2120 cm⁻¹, there was an absorption peak for carbon-carbon triple bonds on the alkyne; at 1672 cm⁻¹, there was an absorption peak for C═C in polybutadiene; at 1716 cm⁻¹, there was an absorption peak for C═O in acylamide; at 1540 cm⁻¹, there was an in-plane bending vibration peak and C—N stretching peak in amide; and at 1236 cm⁻¹, there was an absorption peak for amide. It should be pointed out that the characteristic absorption peak of the NCO group did not appear in the range of 2280 cm⁻¹ to 2230 cm⁻¹, indicating that NCO has completely reacted.

### Step 2 Preparation of Graphdiyne Dispersion Liquid

2.1) 50 parts of ground calcium carbide, 35 parts of hexabromobenzene, a small amount of anhydrous ethanol, and multiple grinding balls were weighed and added to the ball milling tank. After sealed, the grinding reaction was performed in a rotary speed machine. After baking, the product was placed in an argon protected calcination furnace for calcination. After 2 hours to 3 hours, the calcined products were washed successively with dilute nitric acid and deionized water. After cleaned, the sample was baked to remove moisture, resulting in a black powder, i.e. graphdiyne.

2.2) Then the above-mentioned graphdiyne was added to the colorless liquid (polyurethane dispersant) in step 1 and stirred rapidly for 1 hour to obtain a graphdiyne dispersion liquid (with a mass fraction of 50% of graphdiyne). The viscosity of the graphdiyne dispersion liquid (polyurethane dispersion) was 8000 mPa·s to 10000 mPa·s at 23° C.

### Embodiment 2: Preparation of Polyurethane Prepolymer

100 parts of liquefied MDI type 100LL from Wanhua Chemical Group Co., Ltd, 40 parts of PPG-1000 polyether polyols (Shandong Lanxing East Chemical Co., Ltd.; molecular weight 1000), 5 parts of 2,4-hexane-1,6-diol, and 0.02 part of dibutyltin dilaurate were weighed and added into a reaction vessel, and the reaction was stirred under vacuum at 80° C. for 3 hours. The viscosity of the light yellow viscous liquid was 20000 mPa·s to 30000 mPa·s at 23° C.

### Embodiment 3: Preparation of Bi-Component Polyurethane Adhesive I Containing Dispersed Liquid

Component A: 100 parts of the polyurethane prepolymer prepared in Embodiment 2, 50 parts of the polyurethane dispersion containing graphdiyne prepared in Embodiment 1, 2 parts of Cabot LM-150 gas-phase white carbon black, and 1 part of oxazolidine type ALT 202 of Anxiang Alite Chemical Co., Ltd. were weighed and added into a planetary machine and stirred under vacuum at 25° C. for 2 hours.

Component B: Take 60 parts of polyol type Sovermol 760 from BASF (polyether branched chain polyol with viscosity of 2000 mPa·s to 4000 mPa·s, the same below), 30 parts of Stepan's polyester polyol type PD56, 10 parts of hydroxyl terminated polybutadiene polyol type Ricon 130 from Ravelli Carbon Chemical company, 0.01 part of dibutyltin dilaurate as catalyst, 50 parts of graphdiyne dispersion liquid containing graphdiyne prepared in Embodiment 1, and 0.5 part of dustproof agent type BYK-d410 from Bike Chemicals company. After vacuum stirred at 100° C. for 2 hours in a planetary machine, the mixture was cooled to room temperature. Component A and component B were mixed in a ratio of 1:1 to obtain a bi-component polyurethane adhesive.

### Embodiment 4: Preparation of Bi-Component Polyurethane Adhesive II Containing Dispersed Liquid

Component A: 100 parts of the polyurethane prepolymer prepared in Embodiment 2, 100 parts of the polyurethane dispersion containing graphdiyne prepared in Embodiment 1, 2 parts of Cabot LM-150 gas-phase white carbon black, and 1 part of oxazolidine type ALT 202 of Anxiang Alite Chemical Co., Ltd. were weighed and added into a planetary machine and stirred under vacuum at 25° C. for 2 hours.

Component B: Take 60 parts of polyol type Sovermol 760 from BASF, 30 parts of Stepan's polyester polyol type PD56, 10 parts of hydroxyl terminated polybutadiene polyol type Ricon 130 from Ravelli Carbon Chemical company, 0.01 part of dibutyltin dilaurate catalyst, 100 parts of graphdiyne dispersion liquid containing graphdiyne prepared in Embodiment 1, and 0.5 part of dustproof agent type BYK-d410 from Bike Chemicals company. After vacuum stirred at 100°° C. for 2 hours in a planetary machine, the mixture was cooled to room temperature.

Component A and component B were mixed in a ratio of 1:1.

### Embodiment 5: Preparation of Bi-Component Polyurethane Adhesive III Containing Dispersed Liquid

Component A: 100 parts of the polyurethane prepolymer prepared in Embodiment 2, 150 parts of the graphdiyne dispersion liquid containing graphdiyne prepared in Embodiment 1, 2 parts of Cabot LM-150 gas-phase white carbon black, and 1 part of oxazolidine type ALT 202 of Anxiang Alite Chemical Co., Ltd. were weighed and added into a planetary machine and stirred under vacuum at 25° C. for 2 hours.

Component B: Take 60 parts of polyol type Sovermol 760 from BASF, 30 parts of Stepan's polyester polyol type PD56, 10 parts of hydroxyl terminated polybutadiene polyol type Ricon 130 from Ravelli Carbon Chemical company, 0.01 part of dibutyltin dilaurate catalyst, 150 parts of graphdiyne dispersion liquid containing graphdiyne prepared in Embodiment 1, and 0.5 part of dustproof agent type BYK-d410 from Bike Chemicals company. After vacuum stirred at 100°° C. for 2 hours in a planetary machine, the mixture was cooled to room temperature.

Component A and component B were mixed in a ratio of 1:1.

### Embodiment 6: Preparation of Bi-Component Polyurethane Adhesive IV Containing Dispersed Liquid

Component A: 100 parts of the polyurethane prepolymer prepared in Embodiment 2, 200 parts of the graphdiyne dispersion liquid containing graphdiyne prepared in Embodiment 1, 2 parts of Cabot LM-150 gas-phase white carbon black, and 1 part of oxazolidine type ALT 202 of Anxiang Alite Chemical Co., Ltd. were weighed and added into a planetary machine and stirred under vacuum at 25°° C. for 2 hours.

Component B: Take 60 parts of polyol type Sovermol 760 from BASF, 30 parts of Stepan's polyester polyol type PD56, 10 parts of hydroxyl terminated polybutadiene polyol type Ricon 130 from Ravelli Carbon Chemical company, 0.01 part of dibutyltin dilaurate catalyst, 200 parts of graphdiyne dispersion liquid containing graphdiyne prepared in Embodiment 1, and 0.5 part of dustproof agent type BYK-d410 from Bike Chemicals company. After vacuum stirred at 100°° C. for 2 hours in a planetary machine, the mixture was cooled to room temperature.

Component A and component B were mixed in a ratio of 1:1.

### Comparative Embodiment 1: Preparation of Bi-Component Polyurethane Adhesive V Containing Graphdiyne

Component A: 100 parts of the polyurethane prepolymer prepared in Embodiment 2, 100 parts of the graphdiyne powder without polyurethane dispersion added in step 2 of Embodiment 1, 2 parts of Cabot LM-150 gas-phase white carbon black, and I part of oxazolidine type ALT 202 of Anxiang Alite Chemical Co., Ltd. were weighed and added into a planetary machine and stirred under vacuum at 25° C. for 2 hours.

Component B: Take 60 parts of polyol type Sovermol 760 from BASF, 30 parts of Stepan's polyester polyol type PD56, 10 parts of hydroxyl terminated polybutadiene polyol type Ricon 130 from Ravelli Carbon Chemical company, 0.01 part of dibutyltin dilaurate catalyst, 100 parts of the graphdiyne powder without polyurethane dispersion added in step 2 of Embodiment 1, and 0.5 part of dustproof agent type BYK-d410 from Bike Chemicals company. After vacuum stirred at 100° C. for 2 hours in a planetary machine, the mixture was cooled to room temperature.

Component A and component B were mixed in a ratio of 1:1.

### Comparative Embodiment 2: Preparation of Bi-Component Polyurethane Adhesive VI Containing Graphdiyne

Component A: 100 parts of conventional carbodiimide-modified liquefied MDI type LL produced in Jinhu company, South Korea, 100 parts of the graphdiyne powder without polyurethane dispersion added in step 2 of Embodiment 1, 2 parts of Cabot LM-150 gas-phase white carbon black, and 1 part of oxazolidine type ALT 202 of Anxiang Alite Chemical Co., Ltd. were weighed and added into a planetary machine and stirred under vacuum at 25° C. for 2 hours.

Component B: Take 60 parts of polyol type Sovomol 760 from BASF, 30 parts of Stepan's polyester polyol type PD56, 10 parts of hydroxyl terminated polybutadiene polyol type Ricon 130 from Ravelli Carbon Chemical company, 0.01 part of dibutyltin dilaurate catalyst, 100 parts of the graphdiyne powder without polyurethane dispersion added in step 2 of Embodiment 1, and 0.5 part of dustproof agent type BYK-d410 from Bike Chemicals company. After vacuum stirred at 100°° C. for 2 hours in a planetary machine, the mixture was cooled to room temperature.

Component A and component B were mixed in a ratio of 1:1.

### Comparative Embodiment 3: Preparation of Bi-Component Polyurethane Adhesive VII Without Graphdiyne

Component A: 100 parts of the polyurethane prepolymer prepared in Embodiment 2, 100 parts of Carbon Black, 2 parts of Cabot LM-150 gas-phase white carbon black, and 1 part of oxazolidine type ALT 202 of Anxiang Alite Chemical Co., Ltd. were weighed and added into a planetary machine and stirred under vacuum at 25° C. for 2 hours.

Component B: Take 60 parts of polyol type Sovermol 760 from BASF, 30 parts of Stepan's polyester polyol type PD56, 10 parts of hydroxyl terminated polybutadiene polyol type Ricon 130 from Ravelli Carbon Chemicals company, 0.01 part of dibutyltin dilaurate as catalyst, 100 parts of Carbon Black, and 0.5 part of dustproof agent type BYK-d410 from Bike Chemicals company. After vacuum stirred at 100° C. for 2 hours in a planetary machine, the mixture was cooled to room temperature.

Component A and component B were mixed in a ratio of 1:1.

### Embodiment 7

We conducted viscosity tests on the polyurethane adhesive of the above embodiments and comparative embodiments in accordance with the standard in GB/T 2794-2013 Determination of Adhesives-Single Cylinder Rotational Viscometer Method. The test results were as follows:

TABLE 7.1

| | | | Viscosity |
|---|---|---|---|
| | Viscosity of | Viscosity of | of the |
| | Component | Component | mixture/ |
| Sample | A/m · Pa · s | B/m · Pa · s | m · Pa · s |
| Embodiment 3 | 42700 | 48100 | 45000 |
| Embodiment 4 | 78300 | 113000 | 98000 |
| Embodiment 5 | 132100 | 184200 | 153000 |
| Embodiment 6 | 191000 | 242700 | 198000 |
| Comparative | 423900 | 597500 | 436500 |
| embodiment 1 | | | |
| Comparative | 678100 | 597300 | 651200 |
| embodiment 2 | | | |
| Comparative | 103600 | 125300 | 112100 |
| embodiment 3 | | | |

By testing the components and mixed viscosity of the above embodiments and proportions, it can be seen that as the amount of graphdiyne dispersion liquid increased, the components and mixed viscosity of the polyurethane adhesive would also increase. Through the comparison of Embodiment 4 with Comparative embodiment 1 and 2, it can be seen that simply adding graphdiyne without using dispersion would lead to a sharp increase in viscosity. Therefore, polyurethane dispersion has a significant effect on reducing the overall viscosity of graphdiyne and polyurethane system. In Comparative embodiment 2, the polyurethane prepolymer prepared by the present disclosure was not used, instead, conventional carbodiimide-modified liquefied MDI on the market was used. Although the viscosity of liquefied MDI was much lower than that of the polyurethane prepolymer prepared by the present disclosure (the liquefied MDI type LL produced by Jinhu company of South Korea is 50 m·Pa·s to 100 m·Pa·s). Due to the three-dimensional porous structure of graphdiyne, it is easy to adsorb small molecule liquids. Therefore, the viscosity of prepared component A and B was still higher than that of the corresponding components in Comparative embodiment 2. The bi-component polyurethane adhesive with the addition of both polyurethane dispersion liquid and polyurethane prepolymer prepared by the present disclosure exhibited significant advantages in viscosity. Compared with the Comparative embodiment 3 which had only the same mass fraction of carbon black added, the viscosity of Embodiment 4 was slightly higher. Carbon black was a two-dimensional layered graphite, and its adsorption effect was not as good as that of graphdiyne. Therefore, the viscosity of polyurethane adhesive with ordinary carbon black added would be slightly lower.

In addition, we also tested the mechanical strength of the samples of the embodiments and comparative embodiments under natural light for 6 months after curing, and the colloidal foaming performance of the samples at the environment of 80° C. and 60% RH relative humidity for 3 hours. We evaluated the colloidal weather resistance and colloidal solidification foaming by preparing dumbbell shaped samples and the mechanical strength changes of PC/PC shear tensile samples. The specific methods were as follows:

Adhesion testing standard: GB 7124-2008 Determination of tensile shear strength of adhesives (rigid materials to rigid materials).

Colloidal tensile testing standard: GB/T 1040.2-2006 Determination of tensile properties of plastics Part 2: Testing of molded and extruded plastics.

The test results were as follows:

TABLE 7.2

| | Tensile shear | | Tensile shear | |
|---|---|---|---|---|
| | strength of | | strength of | |
| | PC/PC (MPa) | | adhesives (MPa) | |
| | Before | After | Before | After |
| | natural | natural | natural | natural |
| | light | light | light | light |
| Embodiment | irradiation | irradiation | irradiation | irradiation |
| Embodiment 3 | 12.0 | 11.6 | 10.4 | 10.2 |
| Embodiment 4 | 10.7 | 10.5 | 10.0 | 9.8 |
| Embodiment 5 | 10.2 | 10.0 | 9.8 | 9.7 |
| Embodiment 6 | 9.1 | 9.0 | 8.8 | 8.7 |
| Comparative | 7.2 | 7.0 | 6.7 | 6.6 |
| embodiment 1 | | | | |
| Comparative | 5.3 | 5.0 | 4.8 | 4.7 |
| embodiment 2 | | | | |
| Comparative | 9.2 | 4.1 | 8.7 | 3.8 |
| embodiment 3 | | | | |

From Embodiments 3 to 6, it can be seen that the colloid added with graphdiyne dispersion liquid under natural light irradiation had not undergone significant changes in both the adhesive strength with PC and the strength of the colloid itself, and its mechanical strength remained excellent. Especially in Embodiment 4, the shear strength attenuation intensity was low after natural light irradiation, and the comprehensive performance was the best. Through the comparison between Embodiment 2 and Comparative embodiment 1 and 2, it can been seen that the mechanical properties of the sample without adding polyurethane dispersion but graphdiyne have decreased. This is because the compatibility between the graphdiyne without adding polyurethane dispersion and the polyurethane colloid itself is not as good as that of the polyurethane adhesive with adding polyurethane dispersion. The reason why the mechanical strength of Comparative embodiment 1 is higher than that of Comparative embodiment 2 is that the prepared polyurethane prepolymer has better compatibility with graphdiyne than the liquefied MDI type LL produced by Jinhu company of South Korea, and the degree of phase separation in the colloid is relatively lower, resulting in an increase in mechanical strength. As same with Embodiments 3 to 6, the resistance of colloids of Comparative embodiment 1 and 2 to natural light aging is still relatively good, and the degree of attenuation is low. This is because graphdiyne can block high-intensity ultraviolet light irradiation, thereby improving the weather resistance of the polyurethane adhesive. While in Comparative embodiment 3, due to the absence of graphdiyne, the weather resistance is significantly reduced, and both the strength of bonding PC and the strength of the colloid itself are attenuated by more than 50%. Therefore, adding the graphdiyne dispersion according to the present disclosure significantly improved the weather resistance of polyurethane adhesive.

The viscosity of carbon black is relatively low, while the viscosity of graphdiyne is relatively high. As both are carbon materials, it is difficult to add graphdiyne to polyurethane colloids. However, by using the graphdiyne dispersant of the present disclosure, which added polyurethane dispersant, graphdiyne could be well added to polyurethane colloids, and polyurethane colloids have good resistance to natural light. This may be because graphdiyne is rich in alkyne, while polyurethane dispersants contain both alkenyl and alkyne, as well as polyurethane main chains, which can promote good compatibility before graphdiyne and polyurethane colloids, acting as lubricants.

Foaming experiment: the prepared shear tensile and dumbbell colloid samples were placed in a constant temperature and humidity box, with the temperature at 80° C., and the relative humidity of 60%.

TABLE 7.3

| | Solidified at 80° C., | | |
|---|---|---|---|
| | and 60% | | Solidified at |
| | relative humidity | | 80° C., and |
| | Tensile | Tensile | 60% relative |
| | shear | shear | humidity |
| | strength | strength of | Colloidal |
| | of PC/PC | adhesives | foaming |
| Embodiment | (MPa) | (MPa) | situation |
| Embodiment 3 | 11.0 | 9.4 | Not foam |
| Embodiment 4 | 10.8 | 10.7 | Not foam |
| Embodiment 5 | 10.4 | 10.2 | Not foam |
| Embodiment 6 | 9.3 | 9.3 | Not foam |
| Comparative embodiment 1 | 7.0 | 6.3 | Not foam |
| Comparative embodiment 2 | 5.4 | 4.7 | Not foam |
| Comparative embodiment 3 | 3.9 | 1.7 | Severe foaming |

Through the comparison of Embodiments 3 to 6 and Comparative embodiment 3, it can be found that adding graphdiyne could effectively avoid foaming during the polyurethane curing process. It is because during the polyurethane curing process, the foaming cause is the reaction between water vapor and NCO producing CO₂. Once CO₂ generates small bubble nuclei, it continuously converges into visible large bubbles. However, due to the three-dimensional porous structure with a large specific surface area and the easy adsorption of CO₂ by polyyne groups, graphdiyne prevents the small bubble nuclei from further expanding into bubbles to form large pores in the colloid. Therefore, there is no changes in the adhesive strength and colloid strength. From the above data, it can be seen that in terms of avoiding bubbles alone, the effect of graphdiyne and graphdiyne dispersions liquid is similar. However, graphdiyne powder can lead to an increase in colloid viscosity and a significant decrease in colloid mechanical strength. The polyurethane colloid added with the graphdiyne dispersion liquid exhibits the best comprehensive performance.

The technical features of the embodiments above can be combined arbitrarily. To simplify description, all possible combinations of the technical features of the embodiments above are not described. However, as long as there is no contradiction in the combination of these technical features, they should be considered to be within the scope of the specification.

The embodiments above merely express several implementations of the present disclosure. The descriptions of the embodiments are relatively specific and detailed, but may not therefore be construed as the limitation on the patent scope of the present disclosure. It should be noted that a person of ordinary skill in the art may further make several variations and improvements without departing from the concept of the present disclosure. These variations and improvements all fall within the protection scope of the present disclosure. Therefore, the patent protection scope of the present disclosure shall be defined by the appended claims.

What is claimed is:

1. A graphdiyne dispersion liquid, being prepared from graphdiyne powder and polyurethane dispersant, wherein the polyurethane dispersant is an alkyne-end-capped polyurethane dispersant prepared from isocyanate with two to three functionalities and hydroxyl terminated polybutadiene, as well as 4-pentyne-1-ol as an end-capping agent;
wherein, a mass fraction of graphdiyne in the graphdiyne dispersion liquid is 10% to 60%.

2. The graphdiyne dispersion liquid according to claim 1, wherein the isocyanate with two to three functionalities is polymerized MDI, pure MDI, or liquefied MDI, and/or a molecular weight of the hydroxyl terminated polybutadiene is 1000 to 5000.

3. The graphdiyne dispersion liquid according to claim 2, wherein the molecular weight of the hydroxyl terminated polybutadiene is 1500 to 2500.

4. The graphdiyne dispersion liquid according to claim 1, wherein the mass fraction of graphdiyne in the graphdiyne dispersion is 40% to 60%, and/or a mass ratio of the isocyanate with two to three functionalities to the hydroxyl terminated polybutadiene is 100:10 to 110:10 parts.

5. The graphdiyne dispersion liquid according to claim 4, wherein the mass fraction of graphdiyne in the graphdiyne dispersion is 45% to 55%.

6. The graphdiyne dispersion liquid according to claim 1, wherein a viscosity of the polyurethane dispersant is 1000 mPa·s to 2000 mPa·s; and/or a viscosity of the graphdiyne dispersion is 5000 mPa·s to 15000 m Pa·s.

7. The graphdiyne dispersion liquid according to claim 6, wherein the viscosity of the graphdiyne dispersion is 8000 mPa·s to 10000 mPa·s.

8. A bi-component polyurethane adhesive, including polyurethane adhesive component A and polyurethane adhesive component B;
wherein, the polyurethane adhesive component A is prepared from the following raw materials in parts by weight:
100 parts of polyurethane prepolymer;
10 parts to 200 parts of a graphdiyne dispersion liquid, wherein the graphdiyne dispersion liquid is prepared from graphdiyne powder and polyurethane dispersant, wherein the polyurethane dispersant is an alkyne-end-capped polyurethane dispersant prepared from isocyanate with two to three functionalities and hydroxyl terminated polybutadiene, as well as 4-pentyne-1-ol as an end-capping agent, wherein a mass fraction of graphdiyne in the graphdiyne dispersion liquid is 10% to 60%;
1 part to 4 parts of additive;
wherein, the polyurethane prepolymer is prepared from isocyanate with two to three functionalities and polyether polyol as reactants, using 2,4-hexanediyne-1,6-diol as a chain extender;
wherein, the polyurethane adhesive component B is prepared from the following raw materials in parts by weight:
100 parts of polyol;
0.01 part to 0.1 part of catalyst;
10 parts to 200 parts of the graphdiyne dispersion liquid;
0.1 part to 1 part of additive;
wherein, the polyol is selected from at least one of polyether polyol, polyester polyol, plant polyol, and/or polybutadiene polyol, with a viscosity ranging from 1000 to 20000 mPa·s;
when using, the polyurethane adhesive component A and the polyurethane adhesive component B are mixed at a mass ratio of 1:1 to 4:1.

9. The bi-component polyurethane adhesive according to claim 8, wherein the polyurethane adhesive component A and the polyurethane adhesive component B are mixed in the mass ratio of 1:1 to 2:1.

10. The bi-component polyurethane adhesive according to claim 8, wherein the isocyanate with two to three functionalities is polymerized MDI, pure MDI, or liquefied MDI.

11. The bi-component polyurethane adhesive according to claim 8, wherein a viscosity of the polyurethane adhesive component A and/or the polyurethane adhesive component B is between 20000m Pa·s to 250000 mPa·s.

12. The bi-component polyurethane adhesive according to claim 11, wherein the viscosity of the polyurethane adhesive component B is between 50000mPa·s to 200000 mPa·s.

13. The bi-component polyurethane adhesive according to claim 8, wherein a total amount of the graphite acetylene dispersion is 50 parts to 150 parts;
and/or the additive is selected from at least one of thixotropic agent, dust-proof agent, antioxidant, or dehydrating agent;
and/or the catalyst is stannous octanoate, dibutyltin dilaurate, or triethylenediamine, triethanolamine.

14. A preparation method of the bi-component polyurethane adhesive according to claim 8, comprising the following steps:
stirring the polyurethane prepolymer, the additive, and the graphdiyne dispersion liquid under vacuum at 20°° C. to 40°° C. for 0.5 hour to 4 hours to obtain the polyurethane adhesive component A;
stirring the polyol, the catalyst, the additive, and the graphdiyne dispersion liquid under vacuum at 20°° C. to 120° C. for 1 hour to 5 hours to obtain the polyurethane adhesive component B.
